(19) United States
(12) Patent Application Publication
(10) Pub. No.: US 2025/0156039 A1
(43) Pub. Date: May 15, 2025

(54) DISPLAY METHOD AND APPARATUS, ELECTRONIC DEVICE, AND STORAGE MEDIUM

(71) Applicant: Beijing Zitiao Network Technology Co., Ltd., Haidian District, Beijing (CN)

(72) Inventor: Zitong HE, Beijing (CN)

(21) Appl. No.: 18/728,852

(22) PCT Filed: Jan. 6, 2023
(86) PCT No.: PCT/CN2023/070951

§ 371 Date: Jul. 12, 2024

(30) Foreign Application Priority Data
Jan. 14, 2022 (CN) 202210043476.8

(51) Int. Cl. G06F 3/0484; G06F 9/451

(52) U.S. Cl. CPC G06F 3/0484; G06F 9/451

(57) ABSTRACT

A display method and apparatus, an electronic device, and a storage medium. The method comprises: displaying an object identifier and an object control corresponding to at least one object; in response to a trigger operation for a target object control corresponding to a target object, generating a target image corresponding to the target object, wherein the at least one object comprises the target object; and displaying a profile page corresponding to a target user and displaying the target image on the profile page.

### CROSS-REFERENCE TO RELATED APPLICATIONS

The present application is based on and claims priority to CN Patent Application No. 202210043476.8 titled “DISPLAY METHOD AND APPARATUS, ELECTRONIC DEVICE, AND STORAGE MEDIUM” and filed on Jan. 14, 2022, the disclosure of which is incorporated by reference herein in its entirety.

### TECHNICAL FIELD

The present disclosure relates to the field of computer technology, in particular to a display method and apparatus, an electronic device and a storage medium.

### BACKGROUND

With the development of computer science and technology, various applications have emerged. These applications provide people with all-around convenience in life, and some also provide people with abundant options for recreation and entertainment. However, the display and interaction of related applications is relatively simple.

### SUMMARY

In a first aspect of the present disclosure, a display method is provided, which comprises:

displaying an object identifier and an object control corresponding to at least one object;
generating, in response to a trigger operation for a target object control corresponding to a target object, a target image corresponding to the target object, wherein the at least one object comprises the target object; and
displaying a profile page of a target user and displaying the target image on the profile page.

In a second aspect of the present disclosure, a display device is provided, which comprises:

a display module configured to display an object identifier and an object control corresponding to at least one object; and
a processing module configured to generate, in response to a trigger operation for a target object control corresponding to a target object, a target image corresponding to the target object, wherein the at least one object comprises the target object;
the display module is further configured to display a profile page corresponding to a target user and display the target image on the profile page.

In a third aspect of the present disclosure, an electronic device is provided, which comprises a memory, a processor and a computer program stored in the memory and executable on the processor, wherein the method according to the first aspect is implemented when the processor executes the computer program.

In a fourth aspect of the present disclosure, a non-transient computer-readable storage medium is provided, which has computer instructions stored thereon that cause a computer to perform the method according to the first aspect.

### BRIEF DESCRIPTION OF THE ACCOMPANYING DRAWINGS

In order to more explicitly explain the technical solutions in the present disclosure or the relevant art, a brief introduction will be given below for the accompanying drawings required to be used in the description of the embodiments or the relevant art; it is obvious that, the accompanying drawings described as follows are merely the embodiments of the present disclosure, and for those skilled in the art, other accompanying drawings may also be obtained according to such accompanying drawings on the premise that no inventive effort is involved.

FIG. 1 shows a schematic view of a hardware structure of an exemplary electronic device provided by an embodiment of the present disclosure.

FIG. 2 shows a flow chart of an exemplary method provided by an embodiment of the present disclosure.

FIG. 3A shows a schematic view of an exemplary page according to an embodiment of the present disclosure.

FIG. 3B shows a schematic view of an exemplary image according to an embodiment of the present disclosure.

FIG. 3C shows a schematic view of an exemplary page according to an embodiment of the present disclosure.

FIG. 3D shows a schematic view of an exemplary page according to an embodiment of the present disclosure.

FIG. 3E shows a schematic view of an exemplary page according to an embodiment of the present disclosure.

FIG. 3F shows a schematic view of an exemplary page according to an embodiment of the present disclosure.

FIG. 3G shows a schematic view of an exemplary page according to an embodiment of the present disclosure.

FIG. 3H shows a schematic view of an exemplary page according to an embodiment of the present disclosure.

FIG. 3I shows a schematic view of an exemplary page according to an embodiment of the present disclosure.

FIG. 3J shows a schematic view of an exemplary page according to an embodiment of the present disclosure.

FIG. 3K shows a schematic view of an exemplary page according to an embodiment of the present disclosure.

FIG. 3L shows a schematic view of an exemplary page according to an embodiment of the present disclosure.

FIG. 3M shows a schematic view of an exemplary page according to an embodiment of the present disclosure.

FIG. 4 shows a schematic structural view of an exemplary apparatus provided by an embodiment of the present disclosure.

### DETAILED DESCRIPTION

In order to make the object, technical solution and advantages of the present disclosure more explicitly understood, the present disclosure will be further described in detail in conjunction with the specific embodiments and with reference to the accompanying drawings.

It is to be noted that, unless otherwise defined, technical terms or scientific terms used in the embodiments of the present disclosure shall have ordinary meanings as understood by one of ordinary skill in the art to which the present disclosure belongs. The words “first”, “second”, and similar words used in the embodiments of the present disclosure do not denote any order, quantity or importance, but merely serve to distinguish different constituent parts. Similar words such as “comprising” or “containing” mean that an element or article preceding the word covers elements or objects as well as their equivalents listed after the word, but do not exclude other elements or objects. Similar words such as “connecting” or “coupling” are not limited to a physical or mechanical connection, but may comprise electrical connection, regardless of direct or indirect connection. The terms “up”, “down”, “left”, “right”, or the like are used only to represent a relative positional relationship, and the relative positional relationship may also be changed correspondingly if the absolute position of the described object changes.

Simple display and interaction of applications cannot meet diversified needs of a user. In view of this, the present disclosure provides a display method and apparatus, an electronic device and a storage medium.

With the gradual improvement of people's lives, the ways of celebrating holidays are more diversified. In the field of computer technology, it is also necessary to set off a holiday atmosphere in the applications so as to enhance the user experience. However, the related applications are lack of a holiday atmosphere configuration in the user's profile page, so that it is difficult to provide a user with a favorable sense of atmosphere of holidays. In some scenes, it cannot form a favorable undertaking with big events.

In view of this, the embodiment of the present disclosure provides a display method, which displays a corresponding target image in a profile page of a target user based on an object identifier, so as to provide a sense of atmosphere for the target user by using the target image and enhance the user experience.

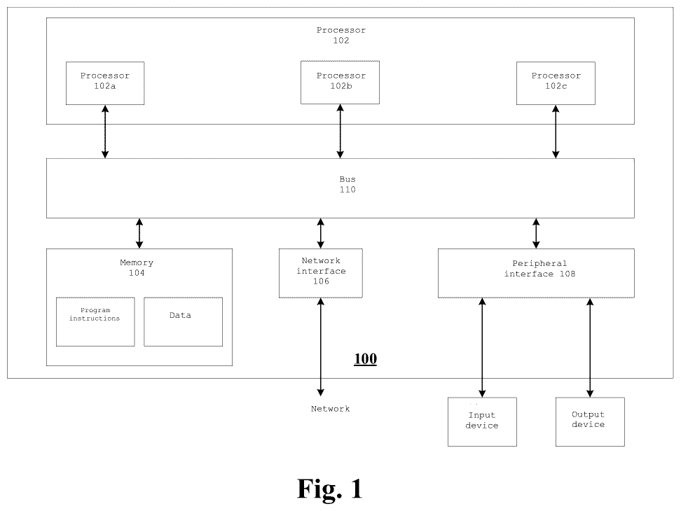

FIG. 1 shows a schematic view of an exemplary electronic device 100 provided by an embodiment of the present disclosure. As shown in FIG. 1, the electronic device 100 may comprise: a processor 102, a memory 104, a network interface 106, a peripheral interface 108 and a bus 110. Wherein, the processor 102, the memory 104, the network interface 106 and the peripheral interface 108 are in communication connection with each other inside the device through the bus 110.

The processor 102 may be a Central Processing Unit (CPU), an image processor, a neural network processor (NPU), a microcontroller (MCU), a programmable logic device, a digital signal processor (DSP), an application specific integrated circuit (ASIC), or one or more integrated circuits. The processor 102 may be configured to perform functions related to the art described in the present disclosure. In some embodiments, the processor 102 may also comprise a plurality of processors integrated into a single logic element. As shown in FIG. 1, the processor 102 may comprise a plurality of processors 102a, 102b and 102c.

The memory 104 may be configured to store data (for example, instructions, computer codes, and the like). As shown in FIG. 1, the data stored in the memory may comprise program instructions (for example, program instructions for implementing the display method of the present disclosure) and data to be processed. The processor 102 may access the program instructions and data stored in the memory, and execute the program instructions to operate on the data to be processed. The memory 104 may comprise a volatile storage device or a nonvolatile storage device. In some embodiments, the memory 104 may comprise a random access memory (RAM), a read-only memory (ROM), an optical disk, a magnetic disk, a hard disk, a solid state hard disk (SSD), a flash memory, a memory stick, and the like.

The network interface 106 may be configured to provide the electronic device 100 with communication with other external devices via a network. The network may be any wired or wireless network capable of transmitting and receiving data. For example, the network may be a wired network, a local wireless network (for example, Bluetooth, WiFi, Near Field Communication (NFC), and the like), a cellular network, Internet, or a combination thereof. It may be understood that, the type of network is not limited to the above-described specific examples. In some embodiments, the network interface 106 may comprise any combination of any number of network interface controllers (NIC), radio frequency modules, transceivers, modems, routers, gateways, adapters, cellular network chips, and the like.

The peripheral interface 108 may be configured to connect the electronic device 100 with one or more peripheral devices for realizing information input and output. For example, the peripheral device may comprise input devices such as a keyboard, a mouse, a touchpad, a touch screen, a microphone and various sensors, as well as output devices such as a display, a speaker, a vibrator and an indicator light.

The bus 110, such as an internal bus (for example, a processor-memory bus) and an external bus (a USB port, a PCI-E bus), may be configured to transmit information between various components of the electronic device 100 (for example, the processor 102, the memory 104, the network interface 106, and the peripheral interface 108).

It is to be noted that, although the above-described device architecture only shows the processor 102, the memory 104, the network interface 106, the peripheral interface 108 and the bus 110, in a specific implementation process, the device architecture may also comprise other components necessary for realizing normal operation. In addition, it may be understood by those skilled in the art that, the above-described device architecture may also comprise only the components necessary for realizing the solution in the embodiment of the present disclosure, rather than necessarily comprising all the components shown in the drawings.

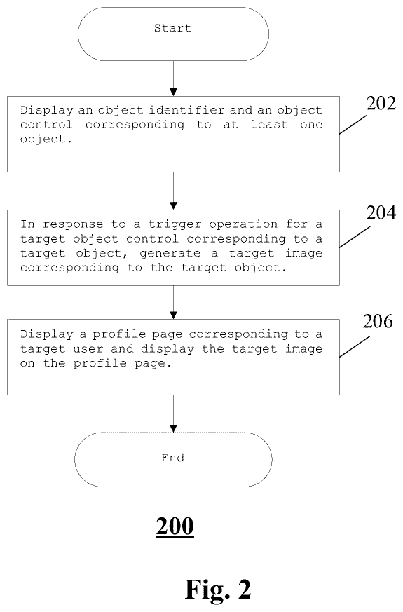

FIG. 2 shows a flow chart of an exemplary method 200 provided by an embodiment of the present disclosure. The method 200 may be implemented by the electronic device 100 of FIG. 1. Referring to FIG. 2, the method 200 may comprise the following steps 202 to 204.

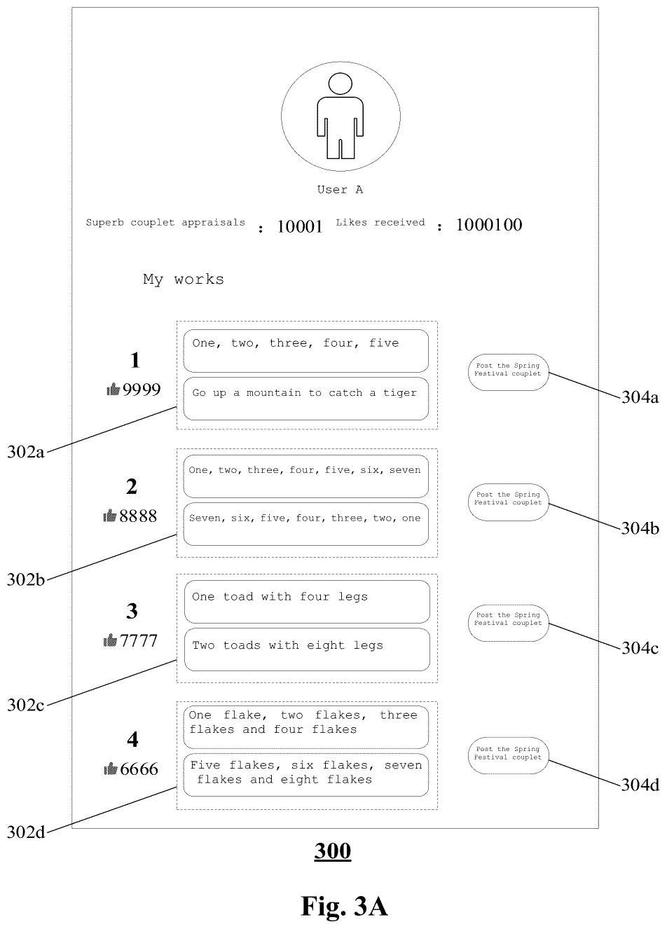

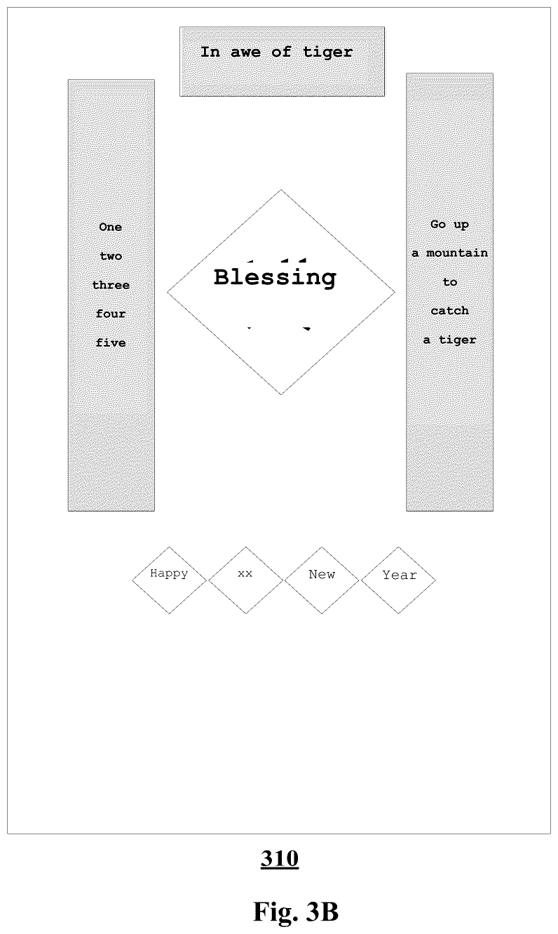

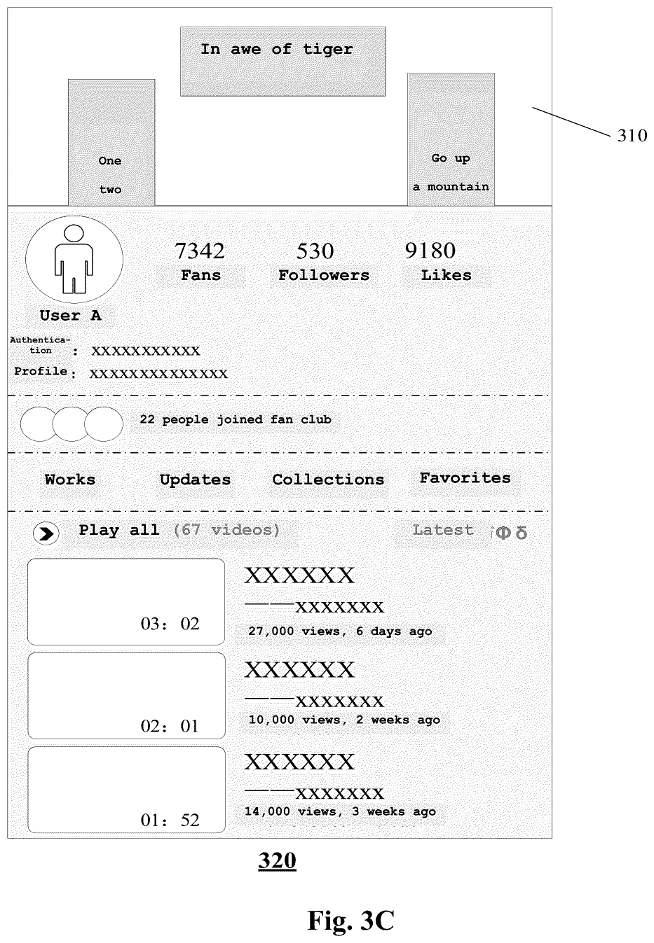

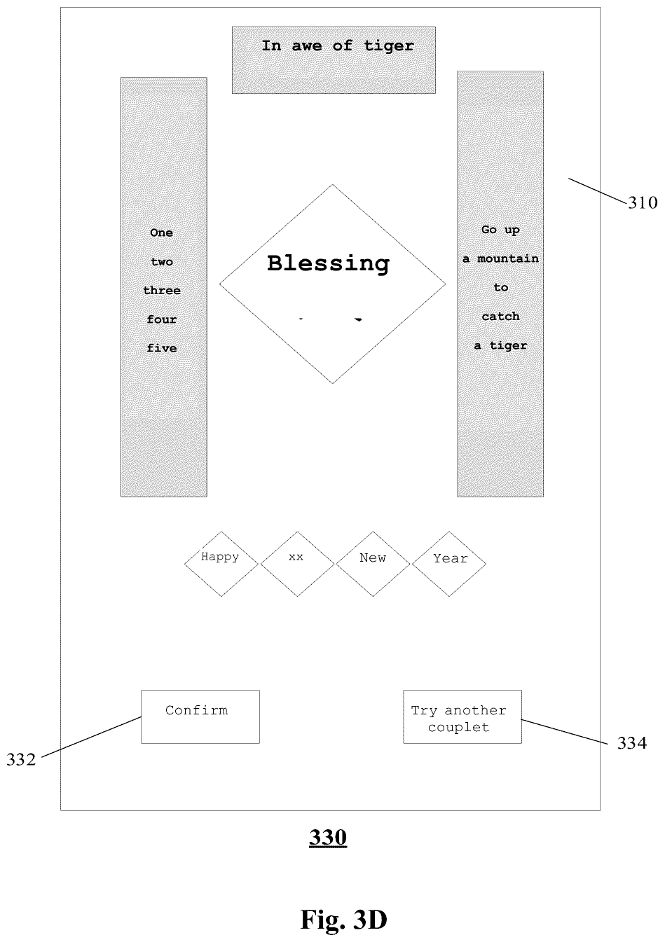

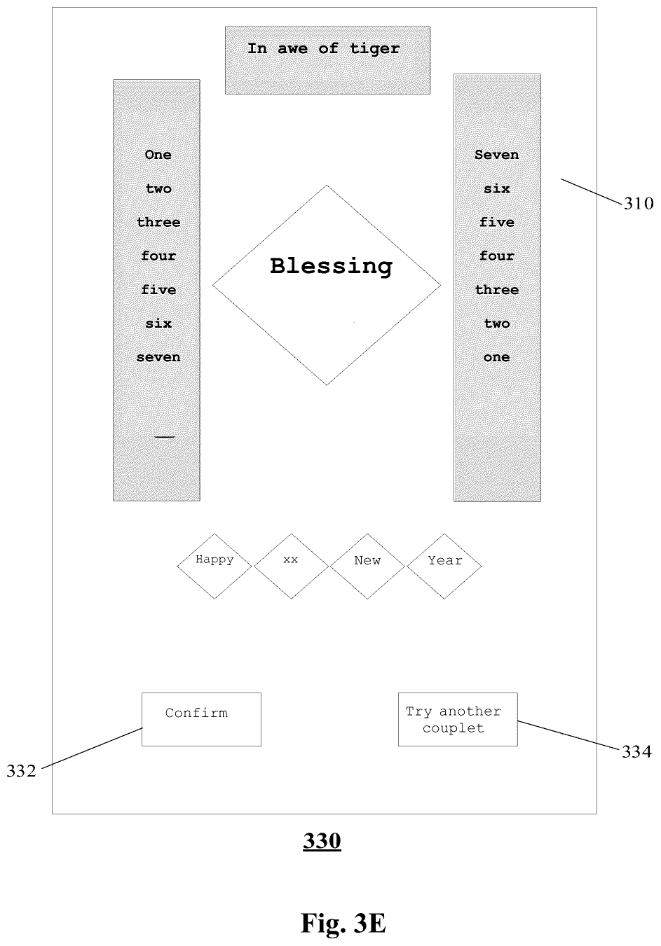

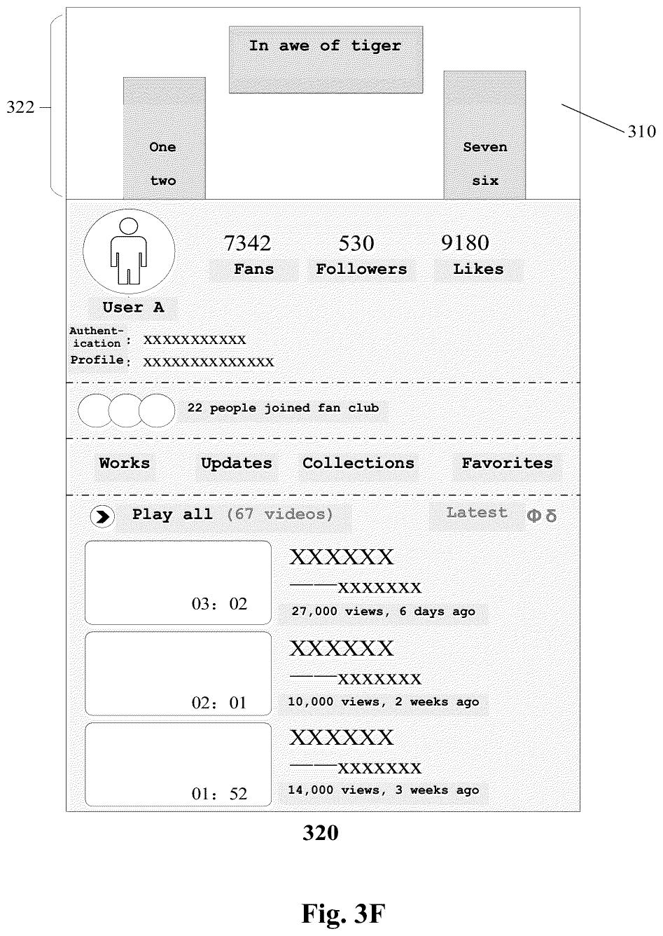

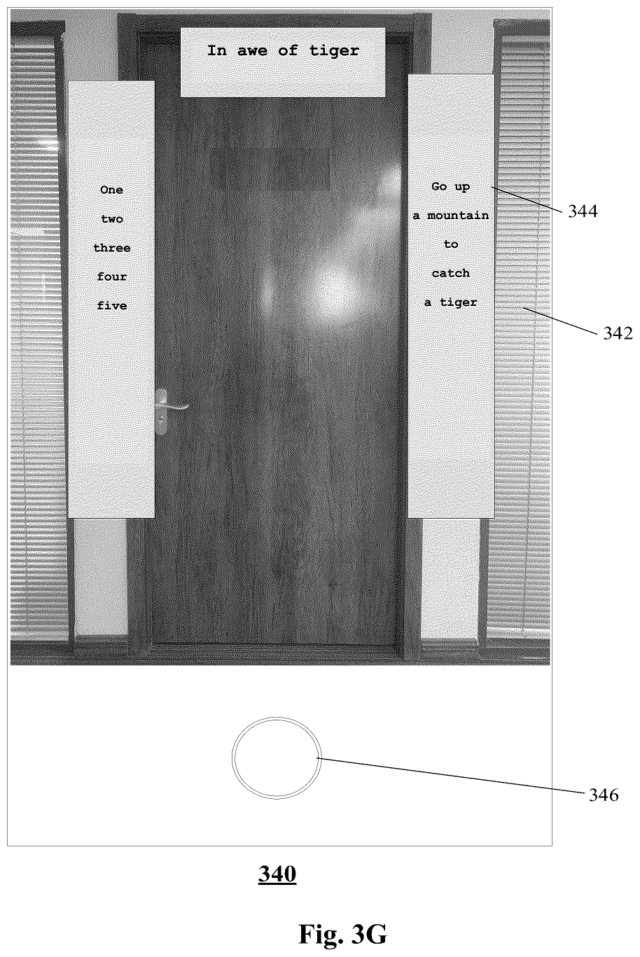

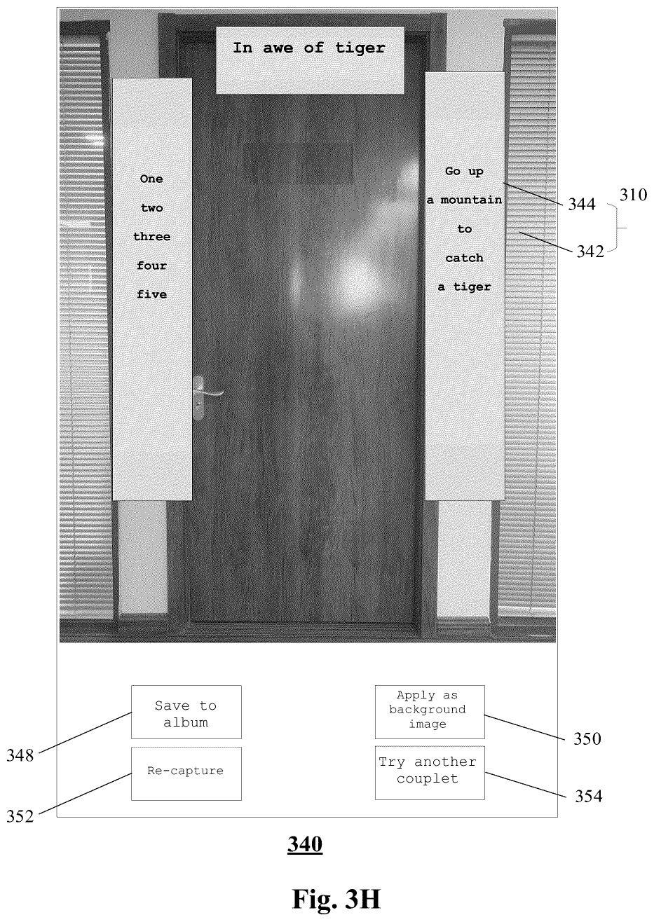

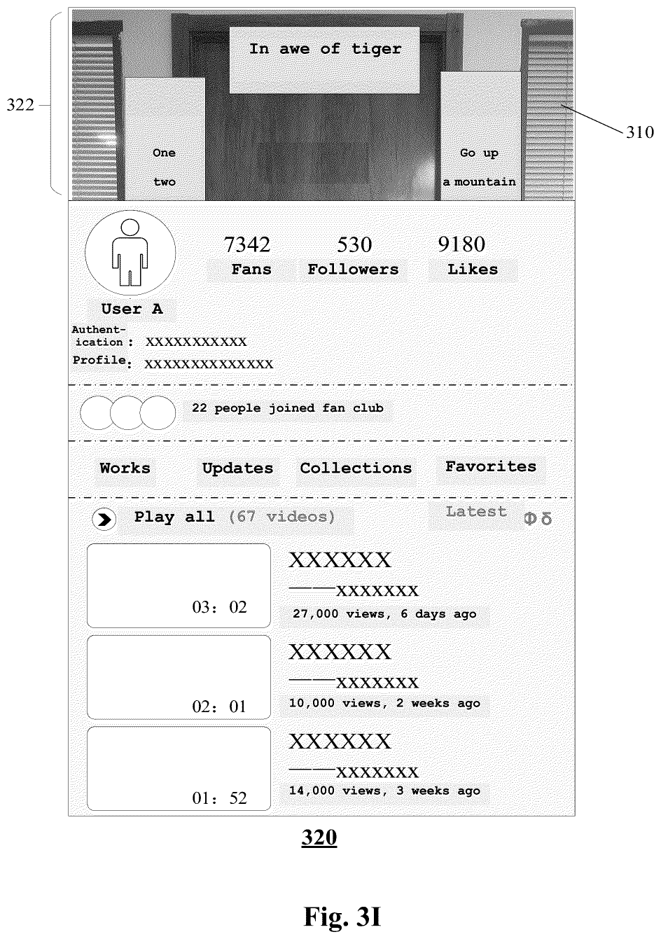

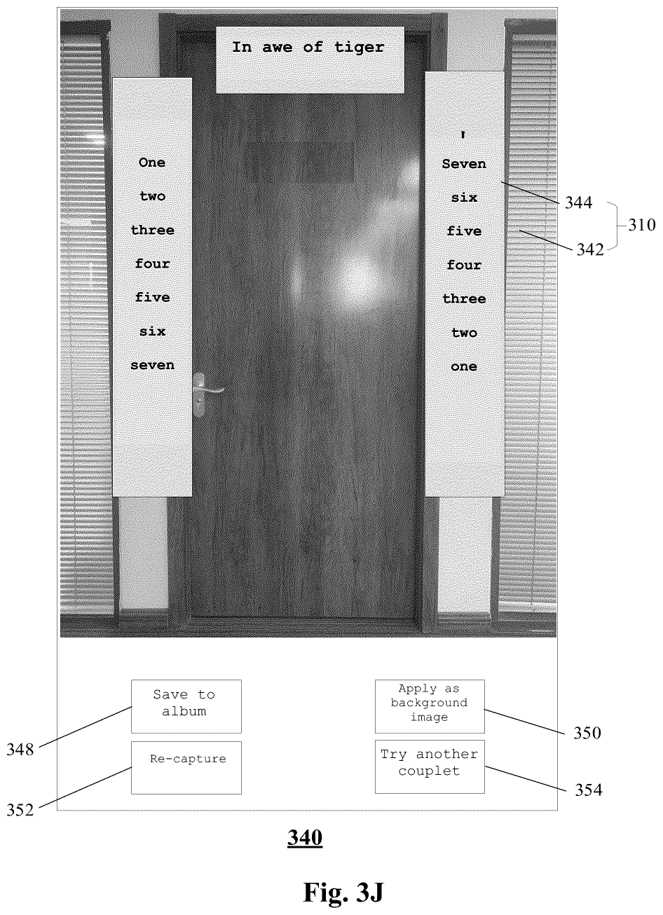

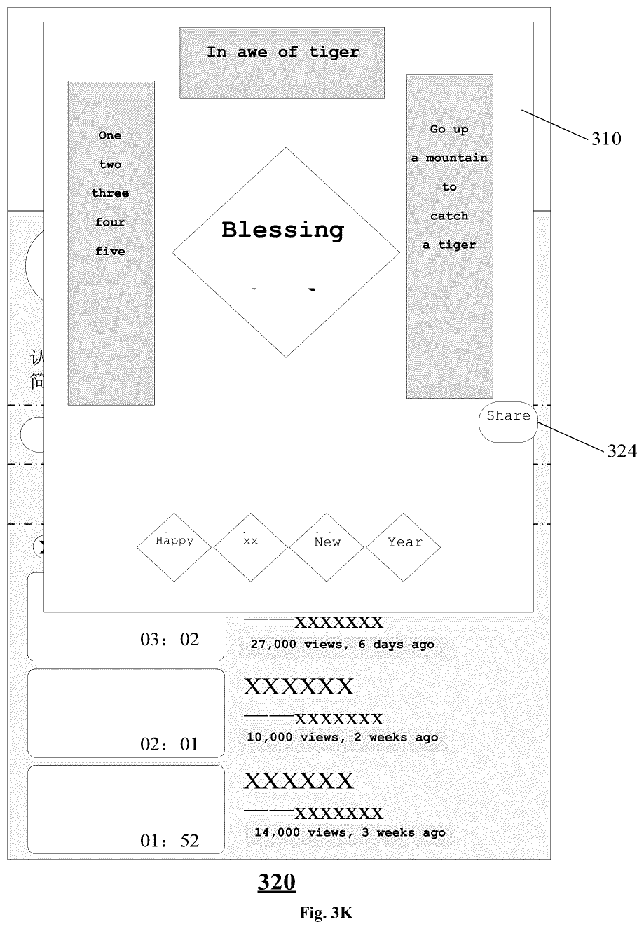

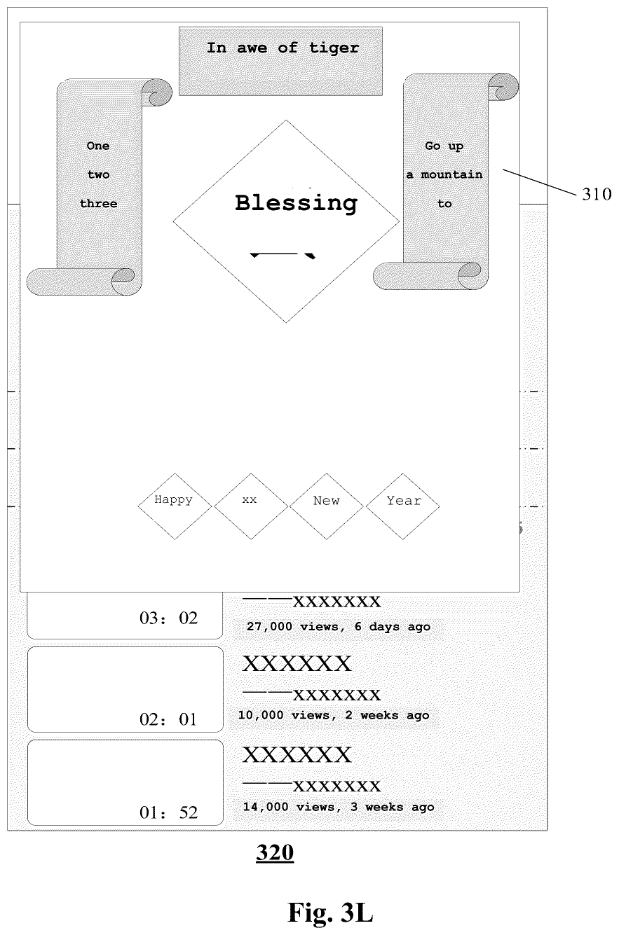

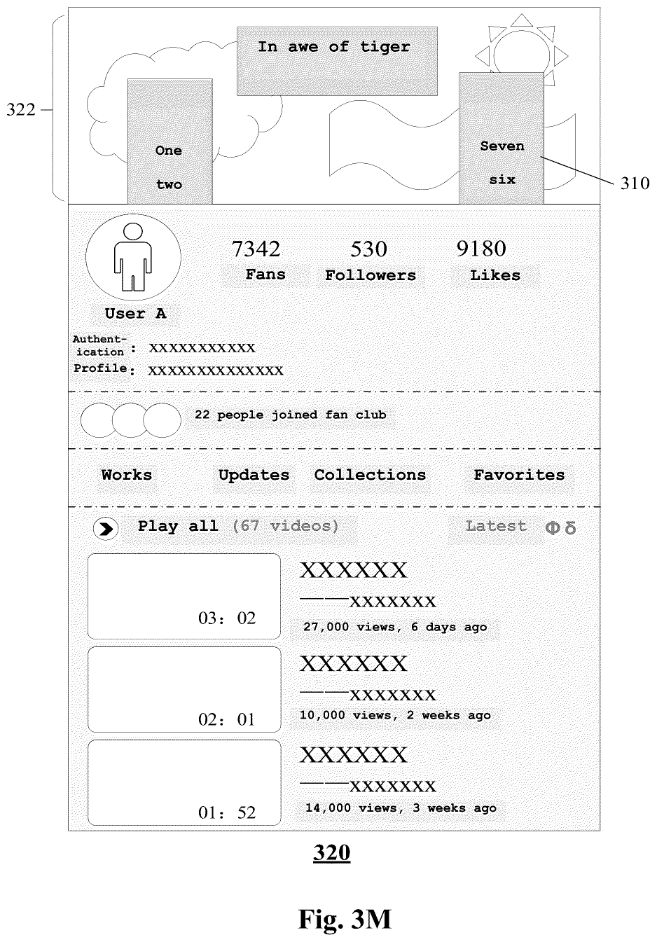

In an initial state, the device 100 may first display a first page 300. FIG. 3A shows a schematic view of an exemplary page 300 according to an embodiment of the present disclosure. The device 100 may access the first page 300 in any manner. For example, the first page 300 is accessed by opening an application (APP). In some embodiments, the first page 300 may be accessed by clicking an entrance (for example, a link) in an APP. The first page 300 may be, for example, an H5 page.

In some embodiments, the first page 300 may be an activity page provided based on a holiday activity. As shown in FIG. 3A, the first page 300 may be a page of a Spring Festival couplet (or a couplet) activity. It may be understood that, the Spring Festival couplet activity page is only exemplary, and the activity scenes corresponding to the activity page may also be other circumstances. For example, there are activity scenes such as a poem antiphon, a lyric antiphon and a song antiphon. In these activity scenes, the activity may be participated by providing an upper line of a couplet, a poem, a lyric or a song in the activity page, and ask the user to provide a lower line of the couplet, the poem, the lyric or the song. Of course, there may be other activity forms, which are only described schematically here.

In Step 202 shown in FIG. 2, as shown in FIG. 3A, the first page 300 may display an object identifier 302a corresponding to at least one object. For example, in the activity scene of Spring Festival couplet, as shown in FIG. 3A, the object identifier 302a may be a Spring Festival couplet copy (for example, “One, two, three, four, five, go up a mountain to catch a tiger”) or its serial number, an outer border of the copy, and the like, and the object corresponding to the object identifier 302a is the Spring Festival couplet itself.

In some embodiments, the object may comprise a plurality of sub-objects. Accordingly, the object identifier of each object (a Spring Festival couplet) on the first page 300 may be preset, or generated based on an interaction operation between the user and the device 100, or preset for some sub-objects of each object, wherein some sub-objects are obtained based on a user input and displayed on the first page after generation. For example, referring to FIG. 3A, the object corresponding to the object identifier 302a is a pair of Spring Festival couplets, which may comprise a first sub-object (for example, an first line) and a second sub-object (for example, a second line). In some embodiments, the Spring Festival couplet may also comprise a third sub-object (for example, a horizontal scroll).

Before displaying the object identifier, the device 100 may first display the first sub-object in the first page 300 (for example, the first line “One, two, three, four, five”). Then, the device 100 may receive a second sub-object input by the user (for example, the second line “Go up a mountain to catch a tiger”). Next, the device 100 may generate a corresponding object identifier (for example, the object identifier 302a of FIG. 3A) in the first page 300 based on the first sub-object and the second sub-object.

In some embodiments, the device 100 may also determine a matching degree between the first sub-object and the second sub-object before generating corresponding object identifiers based on the first sub-object and the second sub-object. For example, the matching degree is determined by performing text analysis according to the texts of the first sub-object and the second sub-object. The matching degree may be determined, for example, by comparing the number of words, parts of speech, phonemes and the like. In some embodiments, the matching degree between the first sub-object and the second sub-object may also be determined based on a matching model trained in advance. The matching model, for example, may be trained based on a neural network model, a Bayesian network model and the like.

When the matching degree between the first sub-object and the second sub-object reaches a preset threshold, the device 100 may display a corresponding object identifier in the first page 300. In some embodiments, if the matching degree between the first sub-object and the second sub-object does not reach a preset threshold, the device 100 may not display a corresponding object identifier in the first page 300. Further, in some embodiments, when the matching degree between the first sub-object and the second sub-object does not reach a preset threshold, the device 100 may also generate a prompt message in the first page 300 to remind the user that the input second sub-object does not match the first sub-object, so that the user may input the second sub-object again.

The object identifier 302a displayed in the first page 300 may be information associated with the content of the first page 300, for example, Spring Festival couplets provided by all the users participating in the Spring Festival couplet activity. In some embodiments, the object identifier 302a shown in the first page 300 may also be information associated with a current user (that is, a target user), for example, the Spring Festival couplet provided by the current user when participating in the Spring Festival couplet activity. In some embodiments, the Spring Festival couplet provided by users when participating in the activity may be collected by sending bullet screens or comments. In some embodiments, considering that user prefers to decorate own page with self-created Spring Festival couplet, the first page 300 may display the information associated with the current user (that is, the target user, for example, the user A in FIG. 3A) by default.

In some embodiments, the number of object identifiers may be multiple. For example, as shown in FIG. 3A, the first page 300 may comprise object identifiers 302a˜302d. When the first page 300 displays a plurality of object identifiers 302a to 302d, these object identifiers 302a˜302d may be sorted. For example, as shown in FIG. 3A, according to the number of likes of the object identifiers, they are arranged according to a descending sequence.

In some embodiments, considering a limited display space of the first page 300, a predetermined number (for example, four in FIG. 3A) of the object identifiers 302a˜302d arranged ahead may be displayed, and the rest (if any) may not be displayed.

In some embodiments, the first page 300 may also be provided with an object control. For example, as shown in FIG. 3A, object controls 304a˜304d may be correspondingly arranged beside the object identifiers 302a˜302d in the first page 300, so that the user may generate a corresponding trigger operation by clicking a target object control (for example, an object control 304a) corresponding to a target object identifier (for example, an object identifier 302a).

Next, in step 204 shown in FIG. 2, the user may select a target object identifier among the object identifiers 302a˜302d of the first page 300 to perform a trigger operation. For example, when the user clicks the object control 304a corresponding to the object identifier 302a in FIG. 3A, the device 100 may generate a target image corresponding to the target object (for example, an object corresponding to the object identifier 302a).

FIG. 3B shows a schematic view of an exemplary image 310 according to an embodiment of the present disclosure. In some embodiments, as shown in FIG. 3B, the target image 310 may be generated based on a preset template. Taking FIG. 3B as an example, the target image 310 may also generate other contents based on the preset template, in addition to corresponding target images (for example, the couplet on the left and right sides in FIG. 3B) based on the object identifier 302a. For example, a horizontal scroll of the Spring Festival couplet is generated at the top of the target image 310, and a word “Blessing” may be generated at the center of the target image 310 and the words “Happy New Year” may be generated at the bottom of the target image 310. By generating the target image 310 based on the preset template, it is possible to save the trouble of manually arranging and designing the target objects, and at the same time, the processing speed of the device 100 will also be faster. It may be understood that, the target images generated according to different preset templates may be different, and the styles of the target images will be exemplified here.

In some embodiments, the font of the text in the target image 310 may also be adjusted to make the target image 310 more in line with the font custom in an actual scene. As shown in FIG. 3C, STXingkai is selected for the font of the text in the target image 310, which makes the target image 310 more tangible in the Spring Festival couplet in the real life scene.

It may be understood that, the trigger operation is not limited to a method of triggering the control, and other trigger methods may also be used to generate the trigger operation. For example, a corresponding trigger operation is generated by double-clicking the object identifier 302a (at this time, the object identifier itself may also serve as an object control), or a corresponding trigger operation is generated by a touch gesture (for example, by sliding from left to right on the corresponding object identifier 302a, at this time, the object identifier itself may also serve as an object control), and so forth.

In some embodiments, the page of the device 100 may jump in response to a trigger operation for a target object control corresponding to a target object. For example, in step 206 shown in FIG. 2, the device 100 may continue to display the second page 320 corresponding to the target user (for example, the user A in FIG. 3A) after generating the target image 310. FIG. 3C shows a schematic view of an exemplary page 320 according to an embodiment of the present disclosure. The second page 320 may comprise the target image 310. In some embodiments, in order to allow the second page 320 to be reflective of personality of the user, the second page 320 associated with the target user may be a profile page of an APP of the target user, as shown in FIG. 3C. The first page 300 may be an activity page of the APP (for example, an activity page of posting the Spring Festival couplet).

In some embodiments, after generating a target image corresponding to the target object, it is possible not to directly display the second page 320, but to first provide an intermediate page 330 before generating the second page 320. FIG. 3D shows a schematic view of an exemplary page 330 according to an embodiment of the present disclosure. As shown in FIG. 3D, the intermediate page 330 may display the target image 310 generated by the device 100. In this way, the user may first preview the target image 310 in the intermediate page 330 to view the effect after the target object is generated as the target image 310 in advance. In some embodiments, the target image 310 generated in the intermediate page 330 may also be generated according to a predetermined template, so that the user may view the actual effect of the target image 310 more visually.

If the user is satisfied with the target image 310 and its display effect, the user may click the confirmation button 332 in the intermediate page 330 to generate a confirmation instruction, so that the device 100 may display the second page 320 associated with the target user (for example, the user A) based on the confirmation instruction, as shown in FIG. 3C.

If the user is not satisfied with the target image 310 or its display effect, the user may perform a switching operation by clicking the switch button 334 in the intermediate page 330. In response to the switching operation, the device 100 may generate a switched target image corresponding to a switched target object based on a preset template. The switched target image may comprise the switched target object image. For example, after receiving the switching operation, a new target object (for example, the object corresponding to the object identifier 302b) may be obtained again from the objects corresponding to the plurality of object identifiers 302b˜302d, and then the target object obtained again may be generated as a new target image 310 in the intermediate page 330 according to the preset template. In this way, the user's selection space is enriched by providing the switching function. FIG. 3E shows a schematic view of an exemplary page 330 according to an embodiment of the present disclosure.

As shown in FIG. 3E, in the intermediate page 330 after switching the target image 310, the object identifier corresponding to the target image 310 is the object identifier 302b in FIG. 3A. At this time, if the user is satisfied with the target image 310 and its display effect, the user may click the confirmation button 332 in the intermediate page 330 to generate a confirmation instruction, so that the device 100 may generate a second page 320 based on the target image 310 in the intermediate page of FIG. 3E, as shown in FIG. 3F.

In the foregoing embodiments, the switching operation is implemented by clicking the switch button 334, and it may be understood that, the switching operation of switching the target image 310 may also be implemented in other methods. For example, by sliding from right to left in the intermediate page 330, the switching operation is implemented based on the touch gesture.

In some embodiments, the target image displayed in the intermediate page may not only be the image generated based on the preset template, but also have more abundant functions. FIG. 3G shows a schematic view of an exemplary page 340 according to an embodiment of the present disclosure. As shown in FIG. 3G, the device 100 may display a camera page 340. For example, the device 100 may obtain an image 342 collected by its camera (for example, a rear camera) and display the image 342 in the camera page 340, and at the same time, a target object image 344 generated based on a target object (for example, an object corresponding to the object identifier 302a in FIG. 3A) may be displayed on the image 342 in a floating manner, thereby forming an augmented reality (AR) effect.

In some embodiments, in response to completion of capturing, the device 100 may generate a target image 310 corresponding to the target object based on a captured image 342 obtained by capturing, as shown in FIG. 3H.

Returning to FIG. 3G, in some embodiments, the camera page 340 may display a camera button 346; after the user clicks the camera button 346, a capturing instruction may be generated, and according to the capturing instruction, the device 100 may fuse the image 342 currently collected by the camera and the target object image 344 into the target image 310, and then obtain an updated camera page 340. FIG. 3H shows a schematic view of an exemplary page 340 according to an embodiment of the present disclosure. As shown in FIG. 3H, after completion of capturing, the camera page 340 is updated in display, wherein the image 342 and the target object image 344 are fused in display as the target image 310. It may be seen that, under the AR effect provided by this embodiment, for example, in the scene of the Spring Festival couplet event, the user may choose a scene where he or she is intended to post the Spring Festival couplet (for example, the door of own home) to capture, and then generate some pictures with the Spring Festival couplet. In this way, by using such pictures in some scenes, it is possible to enhance the sense of atmosphere of holidays and enrich the interaction functions.

Assuming that the user is intended to generate the second page 320 based on the target image 310, the user may click a corresponding trigger button 350 to generate a triggering instruction, so that the device 100 may generate a corresponding second page 320 based on the target image 310, thereby jumping the page from the camera page 340 to the second page 320. In some embodiments, the target image 310 may be displayed as a background in the second page 320. FIG. 3I shows a schematic view of an exemplary page 320 according to an embodiment of the present disclosure. As shown in FIG. 3I, the second page 320 may comprise a background 322, and the target image 310 may be displayed in the second page 320 as a background image in the background 322. In some embodiments, the background 322 may only be located at an upper portion of the second page 320, so that the target image 310 may be partially displayed in the second page 320.

Returning to FIG. 3H, in the camera page 340, a save button 348 may also be provided; by clicking this save button 348, the user may save the target image 310 currently generated to the device 100, for example, to an album folder of the device 100. In this way, by locally saving the target image 310, the user may use the target image 310 in other scenes by retrieving the same locally. In some embodiments, after the user clicks the save button 348, the device 100 may also jump the page to the second page 320, in addition to saving the target image 310 locally. If a corresponding background picture is already present on the second page 320, in some embodiments, the device 100 may also directly replace the existing background picture on the second page 320 with the target image 310.

In some embodiments, as shown in FIG. 3H, the camera page 340 may further comprise a re-capture button 352, and by clicking the re-capture button 352, the camera page 340 may be switched to the camera page 340 of FIG. 3G, so that the user may capture the current scene again or choose a new scene again to capture.

Similarly, as shown in FIG. 3H, the camera page 340 may also comprise a switch button 354 similar to that in FIG. 3D, and the user sends a switching instruction to the device 100 to switch the target object image 344 by clicking the switch button 354. After receiving the switching instruction, the device 100 may determine a new target object again (for example, the object corresponding to the object identifier 302b) from the objects corresponding to the plurality of object identifiers 302b˜302d, and then generate a new target image 310 based on the target object determined again in the camera page 340 according to the preset template, as shown in FIG. 3J. In the embodiment of the present disclosure, a target image (comprising an image of the target object and an additional image corresponding to the preset template) comprising a target object image (i.e., an image of the target object, for example, a couplet image) may be generated by using the preset template, and the operation is simple, so as to meet the requirements of the user for rapidly generating a target image, and the captured image or the locally stored image may also be synthesized with the target object image into the target image, so as to meet the requirements of the user for diversely generating a target image.

In some embodiments, the target image 310 is in a retracted state on the second page 320. Returning to FIG. 3F and FIG. 3I, it may be seen that, as some embodiments, an upper portion of the second page 320 comprises a background (a background image area, also referred to as an avatar image area) 322, and the target image 310 is partially displayed in this background 322 to present a retracted state (that is, the Spring Festival couplet are displayed in a rolled-up scroll state), thereby providing a holiday atmosphere by using the target image 310 in the background 322 of the second page 320. In some embodiments, the target image 310 partially displayed may display its upper portion (or a head portion), as shown in FIGS. 3F and 3I.

Further, in some embodiments, the user may also switch the target image 310 in a retracted state to a deployed state in the second page 320. For example, in response to a trigger operation for the second page 320, the target image 310 is switched from a retracted state to a deployed state, thereby improving the display flexibility of the target object and enriching the interaction methods. For example, the user sends a triggering instruction for deploying the target image 310 to the device 100, so that the device 100 may deploy and display the target image 310 in the second page 320 in a floating manner based on the triggering instruction, as shown in FIG. 3K. It may be understood that, the triggering instruction may be sent in any manner. In some embodiments, the user may send the triggering instruction by clicking or double-clicking the location of the target image 310.

In some embodiments, the process of deploying the target image 310 may also add corresponding effects. For example, in the scene where the target image 310 is a Spring Festival couplet, the target image 310 in the second page 320 may be deployed by using an effect of deploying the scroll. FIG. 3L shows a schematic view of an exemplary page 320 according to an embodiment of the present disclosure. As shown in FIG. 3L, when the target image 310 is deployed in the second page 320, an effect of deploying the scroll may be added to the target image 310, so that the user may have a tangible feeling of posting the Spring Festival couplet. The deployed target image 310 may be as shown in FIG. 3K.

Returning to FIG. 3K, in some embodiments, after the target image 310 is deployed, the second page 320 may provide a sharing button 324 on one side of the target image 310; by clicking the sharing button 324, the user may send a sharing instruction for sharing the target image 310 to the device 100, so that the device 100 may generate a sharing message based on the target image 310 and send the sharing message to a designated user, thereby further enriching the interaction methods. The designated user may be a user set to be a default contact by the user. In some embodiments, the device 100 may generate a new page (not shown in the drawings) based on the sharing instruction, so that the page provides some user identifiers to be selected by the user for share, and the user may select a corresponding identifier for share.

The sharing message may be in any format. For example, in some embodiments, the sharing message may comprise a link to open a page corresponding to FIG. 3D or FIG. 3G, and the user who receives the sharing message may jump to the page corresponding to FIG. 3D or FIG. 3G by clicking the sharing message, and then may perform some processing operations in the aforementioned corresponding embodiments, for example, switching a sticker, capturing an actual scene to generate a target image and the like.

In other embodiments, the sharing message may comprise a request to open a second page (for example, a profile page) corresponding to the designated user and generate the target image 310 in the second page; the user who receives the sharing message may jump to his or her own second page by clicking the sharing message and display the target image 310 in the second page, so that the designated user may generate the target image 310 in his or her own second page by clicking the sharing message.

It may be understood that, the above-described examples only schematically explain the implementation of the sharing message, and other conceivable alternatives may also be applied to the sharing message of the present disclosure as the embodiments of the present disclosure.

It may be understood that, the implementation of the target image 310 in the above-described examples may also have more variations. For example, on such basis that the target image 310 may be displayed on the profile page of the target user, and the profile page of the target user may originally have a background image, in order not to affect the original background display of the profile page, when the target image 310 is generated based on a preset template (as shown in FIG. 3B), the background of the target image 310 may be transparent; in this way, when the device 100 displays the target image 310 on the second page 320, the transparent background of the target image 310 may display the background image in a lower layer, as shown in FIG. 3M.

As may be seen from the above, in the display method provided by an embodiment of the present disclosure, a target image is generated based on a target object selected by the user in the first page, and then the target image is displayed on the profile page corresponding to the target user, thereby providing the target user with an atmosphere on the profile page by using the target image and enhancing the user experience. In some embodiments, the target object may be the Spring Festival couplet, the target image may be a Spring Festival couplet image of a sticker style, and the page associated with the target user may be the profile page of the user; in this way, by using the display method provided by an embodiment of the present disclosure, the user may post the couplet produced during the Spring Festival on the profile page, thereby expanding the functions of the application and enhancing the user experience.

It is to be noted that, the method in an embodiment of the present disclosure may be performed by a single device, for example, a computer or a server. The method of this embodiment may also be applied to a distributed scene, which is accomplished by a plurality of devices cooperating with each other. In this distributed scene, one of the plurality of devices may only perform one or more steps of the method in the embodiment of the present disclosure, and the plurality of devices may interact with each other to complete the method.

It is to be noted that, some embodiments of the present disclosure have been described above. Other embodiments are within the scope of the appended claims. In some cases, the actions or steps recited in the claims may be performed in a different sequence than in the above-described embodiments, and may still achieve a desired result. In addition, the processes depicted in the accompanying drawings do not necessarily require a specific sequence shown or a consecutive sequence to achieve a desired result. In some embodiments, multi-task processing and parallel processing are also possible or might be advantageous.

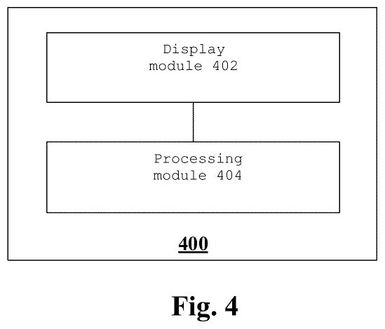

Based on the same inventive concept, corresponding to the method according to any of the above-described embodiments, the present disclosure also provides a body detection device. FIG. 4 shows a schematic structural view of an exemplary apparatus 400 provided by an embodiment of the present disclosure.

Referring to FIG. 4, the display device 400 may comprise a display module 402 and a processing module 404.

The display module 402 is configured to display an object identifier and an object control corresponding to at least one object.

The processing module 404 is configured to generate, in response to a trigger operation for a target object control corresponding to a target object, a target image corresponding to the target object, wherein the at least one object comprises the target object.

The display module 402 is also configured to display a profile page corresponding to a target user and display the target image on the profile page.

In some embodiments, the processing module 404 is configured to generate a target image corresponding to the target object based on a preset template in response to a trigger operation for a target object control corresponding to a target object.

In some embodiments, the processing module 404 is configured to display a camera page in response to a trigger operation for a target object control corresponding to a target object; and generate a target image corresponding to the target object based on the captured image obtained by capturing in response to completion of capturing. The target image comprises the captured image and a target object image displayed on the captured image.

In some embodiments, the processing module 404 is configured to receive a switching operation for the target image; and generate a switched target image corresponding to a switched target object based on a preset template in response to the switching operation.

In some embodiments, the display module 402 is further configured to display the target image in a background of the profile page.

In some embodiments, the target image is in a retracted state on the profile page. In this case, the display module 402 is also configured to switch the target image from a retracted state to a deployed state in response to a trigger operation for the profile page.

In some embodiments, the display module 402 is further configured to deploy the target image on the profile page according to a predetermined effect.

In some embodiments, the processing module 404 is configured to receive a sharing instruction for sharing the target image; and generate a sharing message based on the target image and send the sharing message to a designated user.

For the convenience of description, when the above devices are described, they are divided into various modules according to the functions and described respectively. Of course, the functions of various modules may be implemented in the same one or more software and/or hardware when the present disclosure is implemented.

The device of the above-described embodiment is used to implement the corresponding method 200 in any of the aforementioned embodiments, and has the beneficial effects of the corresponding method embodiment, which will not be described in detail here.

Based on the same inventive concept, corresponding to the method according to any of the above-described embodiments, the present disclosure also provides a non-transient computer-readable storage medium having computer instructions stored thereon, the computer instructions causing the computer to perform the method 200 according to any of the above-described embodiments.

The computer-readable medium of the present embodiment comprises permanent and non-permanent, removable and non-removable medium, and information storage may be implemented by any method or technology. Information may be computer-readable instructions, data structures, modules of programs or other data. Examples of storage media for computers comprise, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, Compact Disc Read-Only Memory (CD-ROM), digital versatile disc (DVD) or other optical storage, magnetic tape of magnetic cassette type, magnetic disk storage of magnetic tape type or other magnetic storage devices, or any other non-transmission medium, which may be used to store information accessible by a computing device.

The computer instructions stored in the storage medium of the above-described embodiments are used to cause the computer to perform the method 200 according to any of the above-described embodiments, and have the beneficial effects of the corresponding method embodiment, which will not be described in detail here.

As may be seen from the above, the display method and device, the electronic device and the storage medium provided by the present disclosure generate a target image based on a target object selected by the user in the first page, and then display the target image in a profile page corresponding to a target user, thereby providing the target user with a sense of atmosphere on the profile page by using the target image, enriching an interaction method, satisfying diversified needs of the user and enhancing the user experience.

It should be understood by those skilled in the art that: the discussion of any of the above embodiments is only exemplary, but not intended to imply that the scope of the present disclosure (comprising the claims) is limited to these examples; under the idea of the present disclosure, the technical features in the above embodiments or different embodiments may also be combined, and the steps may be implemented in any sequence, and there may be many other variations in different aspects of the embodiments of the present disclosure as described above, which are not provided in details for the sake of brevity.

In addition, in order to simplify the explanation and discussion, and avoid obscuring the embodiments of the present disclosure, well-known power/ground connections with an integrated circuit (IC) chip and other components may or may not be shown in the provided accompanying drawings. Further, devices may be shown in a block view form in order to avoid obscuring the embodiments of the present disclosure, and this also takes into account the following fact, that is, details about the implementation of these block view devices are highly dependent on the platform where the embodiment of the present disclosure will be implemented (i.e., these details should be completely within the understanding range of those skilled in the art). In the case where specific details (for example, circuits) are set forth to describe exemplary embodiments of the present disclosure, it is obvious to those skilled in the art that the embodiments of the present disclosure may be implemented without these specific details or with changes in these specific details. Therefore, these descriptions should be regarded as illustrative rather than restrictive.

Although the present disclosure has been described in connection with specific embodiments of the present disclosure, many replacements, modifications and variations of these embodiments will be obvious to those skilled in the art from the foregoing description. For example, other memory architectures (for example, dynamic RAM (DRAM)) may use the discussed embodiments.

The embodiment of the present disclosure are intended to cover all such replacements, modifications and variations that fall within the broad scope of the append claims. Therefore, any omission, modification, equivalent replacement, improvement, and the like made within the spirit and principles of the embodiments of the present disclosure should be comprised in the protection scope of the present disclosure.

What is claimed is:

1. A display method, comprising:
displaying an object identifier and an object control corresponding to at least one object;
generating, in response to a trigger operation for a target object control corresponding to a target object, a target image corresponding to the target object, wherein the at least one object comprises the target object; and
displaying a profile page of a target user and displaying the target image on the profile page.

2. The display method according to claim 1, wherein the generating, in response to a trigger operation for a target object control corresponding to a target object, a target image corresponding to the target object comprises:
generating, in response to a trigger operation for a target object control corresponding to a target object, a target image corresponding to the target object based on a preset template.

3. The display method according to claim 1, wherein the generating, in response to a trigger operation for a target object control corresponding to a target object, a target image corresponding to the target object comprises:
displaying a camera page in response to a trigger operation for a target object control corresponding to a target object; and
generating a target image corresponding to the target object based on the captured image obtained by capturing in response to completion of capturing, wherein the target image comprises the captured image and a target object image displayed on the captured image.

4. The display method according to claim 1, further comprising:
receiving a switching operation for the target image after generating a target image corresponding to the target object; and
generating a switched target image corresponding to a switched target object based on a preset template in response to the switching operation.

5. The display method according to claim 1, wherein the displaying the target image on the profile page comprises:
displaying the target image in a background of the profile page.

6. The display method according to claim 1, wherein the target image is in a retracted state on the profile page, and the display method further comprises:
switching the target image from a retracted state to a deployed state in response to a trigger operation for the profile page.

7. The display method according to claim 6, wherein the switching the target image from a retracted state to a deployed state comprises:
deploying the target image on the profile page according to a predetermined effect.

8. The display method according to claim 1, further comprising:
receiving a sharing instruction for sharing the target image; and
generating a sharing message based on the target image and sending the sharing message to a designated user.

9. The display method according to claim 1, further comprising:
for each object, in the case where each object comprises a plurality of sub-objects, determining a matching degree of the plurality of sub-objects; and
judging whether to display an object identifier and an object control corresponding to each object according to the determined matching degree.

10. The display method according to claim 9, wherein the judging whether to display an object identifier and an object control corresponding to each object according to the determined matching degree comprises:
displaying an object identifier and an object control corresponding to the each object in response to a matching degree of the plurality of sub-objects reaching a preset threshold; and
not displaying an object identifier or an object control corresponding to each object, and prompting that the plurality of sub-objects are not matched in response to a matching degree of the plurality of sub-objects not reaching a preset threshold.

11. (canceled)

12. An electronic device comprising a memory, a processor and a computer program stored in the memory and executable on the processor, wherein a display method is implemented when the processor executes the program, the display method comprising:
displaying an object identifier and an object control corresponding to at least one object;
generating, in response to a trigger operation for a target object control corresponding to a target object, a target image corresponding to the target object, wherein the at least one object comprises the target object; and
displaying a profile page of a target user and displaying the target image on the profile page.

13. A non-transient computer-readable storage medium, wherein the non-transient computer-readable storage medium has computer instructions stored thereon that cause a computer to perform a display method comprising:
displaying an object identifier and an object control corresponding to at least one object;
generating, in response to a trigger operation for a target object control corresponding to a target object, a target image corresponding to the target object, wherein the at least one object comprises the target object; and
displaying a profile page of a target user and displaying the target image on the profile page.

14. (canceled)

15. The electronic device according to claim 12, wherein the generating, in response to a trigger operation for a target object control corresponding to a target object, a target image corresponding to the target object comprises:
generating, in response to a trigger operation for a target object control corresponding to a target object, a target image corresponding to the target object based on a preset template.

16. The electronic device according to claim 12, wherein the generating, in response to a trigger operation for a target object control corresponding to a target object, a target image corresponding to the target object comprises:
displaying a camera page in response to a trigger operation for a target object control corresponding to a target object; and
generating a target image corresponding to the target object based on the captured image obtained by capturing in response to completion of capturing, wherein the target image comprises the captured image and a target object image displayed on the captured image.

17. The electronic device according to claim 12, further comprising:
receiving a switching operation for the target image after generating a target image corresponding to the target object; and
generating a switched target image corresponding to a switched target object based on a preset template in response to the switching operation.

18. The electronic device according to claim 12, wherein the displaying the target image on the profile page comprises:
displaying the target image in a background of the profile page.

19. The non-transient computer-readable storage medium according to claim 13, wherein the generating, in response to a trigger operation for a target object control corresponding to a target object, a target image corresponding to the target object comprises:
generating, in response to a trigger operation for a target object control corresponding to a target object, a target image corresponding to the target object based on a preset template.

20. The non-transient computer-readable storage medium according to claim 13, wherein the generating, in response to a trigger operation for a target object control corresponding to a target object, a target image corresponding to the target object comprises:
displaying a camera page in response to a trigger operation for a target object control corresponding to a target object; and
generating a target image corresponding to the target object based on the captured image obtained by capturing in response to completion of capturing, wherein the target image comprises the captured image and a target object image displayed on the captured image.

21. The non-transient computer-readable storage medium according to claim 13, further comprising:
receiving a switching operation for the target image after generating a target image corresponding to the target object; and
generating a switched target image corresponding to a switched target object based on a preset template in response to the switching operation.

22. The non-transient computer-readable storage medium according to claim 13, wherein the displaying the target image on the profile page comprises:
displaying the target image in a background of the profile page.
